(19) United States
(12) Patent Application Publication
(10) Pub. No.: US 2009/0236777 A1
(43) Pub. Date: Sep. 24, 2009

(54) Method for Manufacturing Bicycle Crank

(76) Inventor: Douglas Chiang, Wufeng Shiang (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/478,845

(22) Filed: Jun. 5, 2009

Related U.S. Application Data
(63) Continuation-in-part of application No. 11/762,753, filed on Jun. 13, 2007.

(51) Int. Cl. B29D 22/00

(52) U.S. Cl. 264/523

(57) ABSTRACT

A method for making a crank of a bicycle includes preparing a prepreg material and a bladder, heat-pressing the prepreg material and the bladder, cutting the prepreg material and the bladder to form two engaging sections to engage with two connectors, wrapping a carbon-fiber cloth, and heating the prepreg material and first and second connectors that is wrapped by the carbon-fiber cloth.

### CROSS REFERENCE

The present application is a continuation-in-part application of U.S. patent application Ser. No. 11/762,753, filed on Jun. 13, 2007, of which the entire disclosure is incorporated herein.

### BACKGROUND OF THE INVENTION

1. Field of the Invention

The present invention relates to a method for making a crank.

2. Description of the Related Art

It is a current trend to make a bicycle crank from carbon-fiber composite material.

A carbon-fiber bicycle crank generally has a five communication tube connected to each end thereof. However, connections therebetween are not good due to that the carbon fiber composite material is very hard and brittle. To strengthen the structure, the crank generally has metal tubes mounted at pivotal connections. Furthermore, carbon-fiber sheets are adhered on the crank to fix the metal tubes with the crank.

To that end, the conventional crank often suffers a structure defect, and it is time consuming during manufacturing. Another problem is that the interior of the crank must be formed with supporting blocks for adhering operation and this incurs increased weight to the crank. Also, when the crank is complete, the metal tubes are buried. However, connection of the crank with the two metal tubes is not solid and strong. Although adhesive is used to increase the connection, the adhesive suffers a problem of buckling. Furthermore, it is difficult to prepare the adhesive.

The present invention is, therefore, intended to obviate or at least alleviate the problems encountered in the prior art.

### SUMMARY OF THE INVENTION

According to the present invention, a method for making a crank of a bicycle includes steps 1) preparing a prepreg material and a bladder in a cavity of a mold insert, with the bladder buried in the prepreg material. 2) heat-pressing the prepreg material and the bladder to inflate the bladder and cause the prepreg material to compactly fit with the shape of the cavity. 3) cutting the prepreg material to form two engaging sections. 4) Tight-fitting a first connector with the engaging section and a second connector with the engaging section, respectively. 5) wrapping a carbon-fiber cloth to cover up the prepreg material and the first and second connectors. 6) heating the prepreg material and the first and second connectors that are wrapped by the carbon-fiber cloth in order to snugly attach the carbon-fiber cloth 40 to the prepreg material and first and second connectors.

It is an object of the present invention to provide a method for making a light-weight, strong crank against buckling.

It is a further object of the present invention to provide a method for making an economical crank.

It is yet another object of the present invention to provide a simple method for making a crank.

### BRIEF DESCRIPTION OF THE DRAWINGS

FIG. 1 is a flow chart of a method for making a crank in accordance with the present invention.

FIG. 2 is cross-sectional view showing a bladder and a prepreg material mounted in a mold insert, with the bladder disposed inside the prepreg material. Additionally, the bladder has a mouth and a valve is connected at the mouth.

FIG. 3 is a cross-sectional view showing the bladder and the prepreg material subject to a heat-pressing process.

FIG. 4 is a side view of the prepreg material after the heat-pressing process.

FIG. 5 is a side view showing both the prepreg material and the bladder cut to form two engaging sections on two ends thereof.

FIG. 6 is a side view showing two connectors utilized for engaging with the two engaging sections respectively.

FIG. 7 is a side view showing the connectors fitted in the engaging sections.

FIG. 8 is a side view showing a carbon-fiber cloth for wrapping an outer periphery of the prepreg material and the connectors.

FIG. 9 is a side view showing the prepreg material and the connectors wrapped by the carbon-fiber cloth.

FIG. 10 is a cross-sectional view showing the wrapped prepreg material and connectors subject to a heating process.

FIG. 11 is a perspective view of the crank in accordance with the present invention.

### DETAILED DESCRIPTION OF THE PREFERRED EMBODIMENT

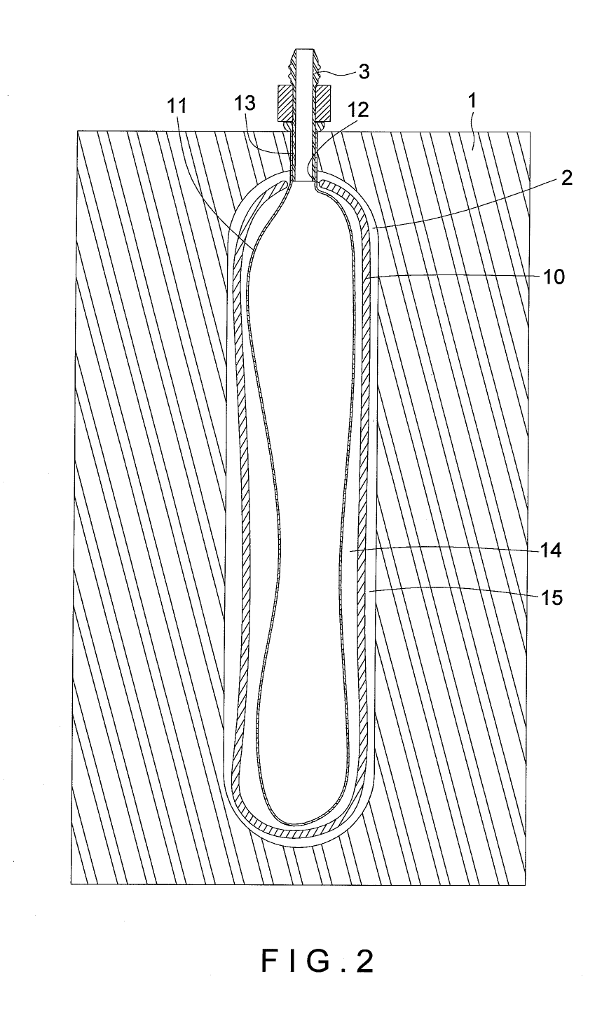

FIG. 2 shows a prepreg material 10 and a bladder 11 for making a crank of the present invention. The prepreg material 10 and the bladder 11 are mounted in a cavity 2 of a mold insert 1. The mold insert 1 may be configured of two complemently fitted mold inserts, and the cavities 2 of the respective mold inserts 1 are configured to correspond with each other. Additionally, the bladder 11 is buried in the prepreg material 10 and the prepreg material 10 leaves a gap 12 with a minimum size to allow a mouth 13 of the bladder 11 to expose outside the prepreg material 10. Preferably, the gap 12 is with a size such that an outer periphery of the mouth 13 is in contact with the prepreg material. Further, the prepreg material 10 and the bladder 11 may have a first space 14 therebetween at this stage. Furthermore, the prepreg material 10 any the cavity 2 may have a second space 15 therebetween at this stage. Moreover, a valve 3 may be connected at the mouth 13 of the bladder 11 to facilitates the bladder 11 to connect with an air supply

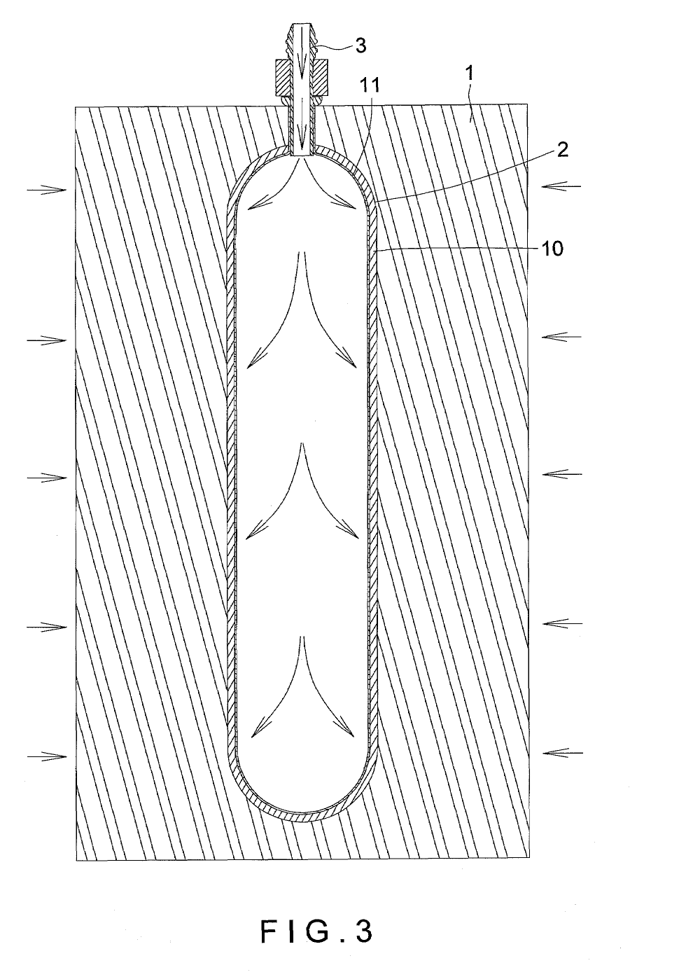

FIG. 3 shows the prepreg material 10 and the bladder 11 subject to a heat-pressing process. Upon the heat-pressing process, the bladder 11 is inflated by air until the first space 14 is eliminated, and thus the bladder 11 is compactly fitted with the prepreg material 10. Also, the prepreg material 10 is inflated by the bladder 11 until the second space 15 is eliminated, and thus the prepreg material 10 is compactly fitted with the shape of the cavity 2.

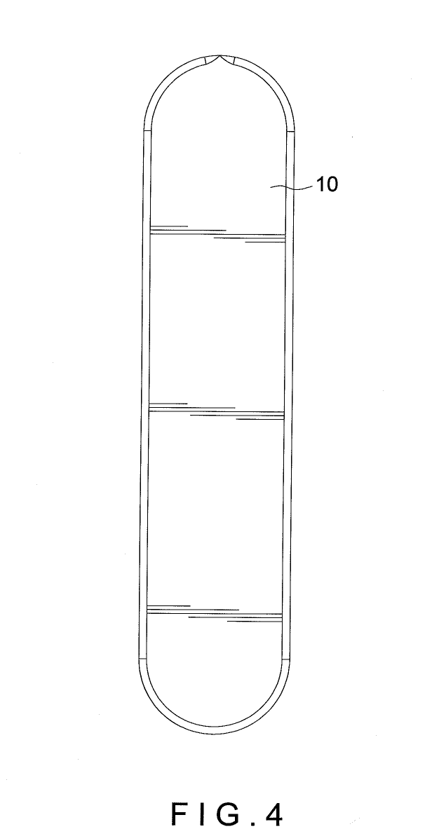

FIG. 4 shows that the prepreg material 10 removed from the mold insert 1 after the heat-pressing process. After the heat-pressing process, the prepreg material 10 becomes solid and the bladder 11 is snugly retained with an inner periphery of the prepreg material 10.

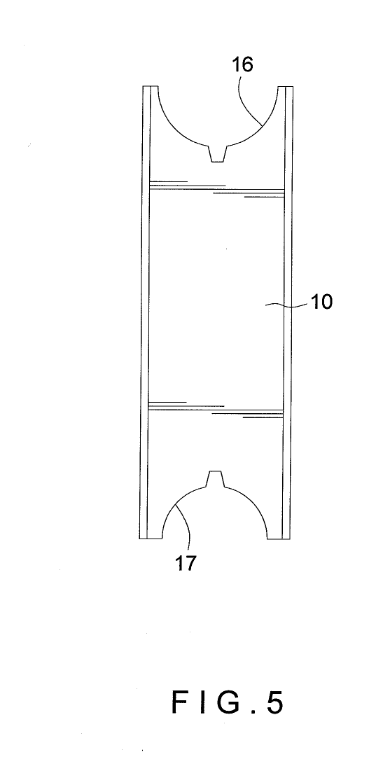

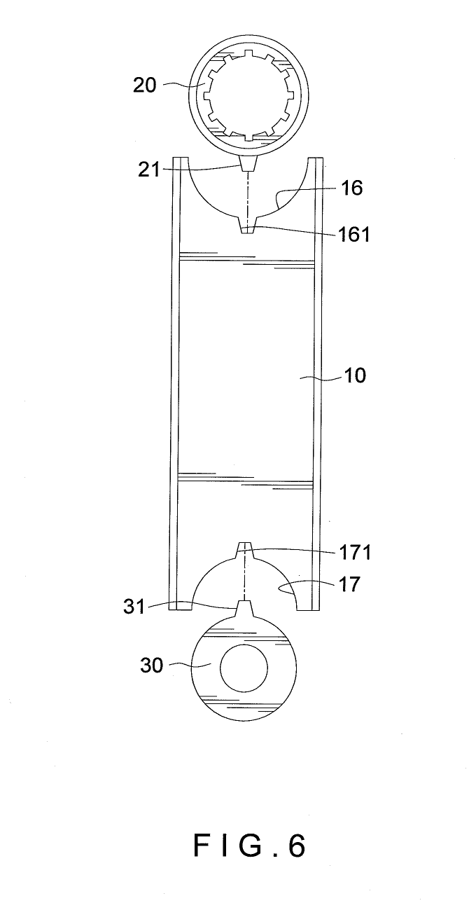

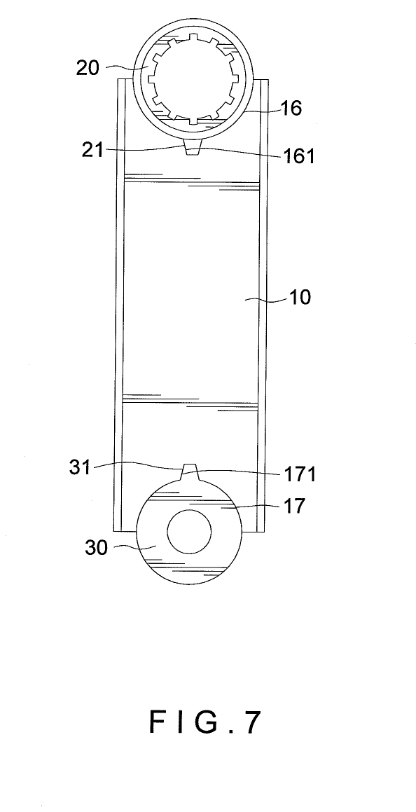

FIG. 5 shows that the prepreg material 10 and the bladder 11 cut to form two engaging sections 16 and 17. The two engaging sections 16 and 17 are utilized to receive a first connector 20 and a second connector 30 respectively, as shown in FIG. 6. The first 20 and second 30 connectors are utilized to connect with a transmission gear of a bicycle (not shown) and a pedal (not shown), respectively. It is understood that rider can operate the pedal to turn the crank and the crank can control rotation of the transmission gear. Additionally, the first 20 and second 30 connectors are preferably made of metal. Further, the first 20 and second 30 connectors are tight-fitted with the two engaging sections 16 and 17, respectively, as shown in FIG. 7. In the preferred embodiment, the first connector 20 includes a protrusion 21 and the engaging section includes a recess 131 for tightly engaging with the protrusion 21. Likewise, the second connector 30 includes a protrusion 31 and the engaging section 14 includes a recess 141 for tight-engagement with the protrusion 31.

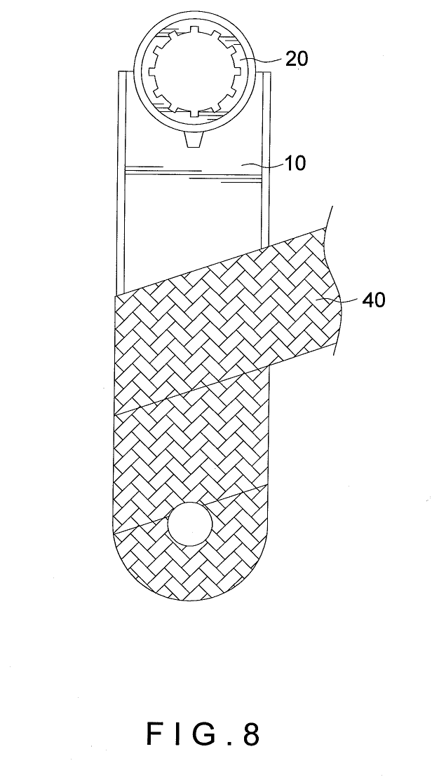

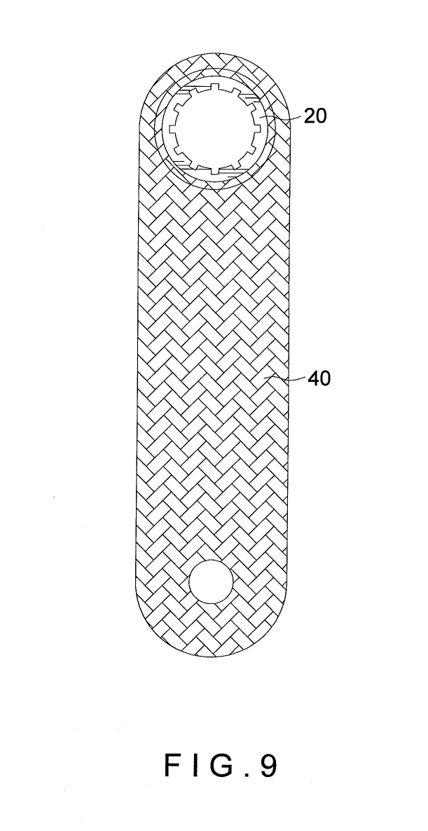

FIG. 8 shows that a carbon-fiber cloth 40 is utilized for wrapping the prepreg material 10 and the first 20 and second 30 connectors, so the prepreg material 10 and the first 20 and second 30 connectors are covered up by the carbon-fiber cloth 40, as shown in FIG. 9.

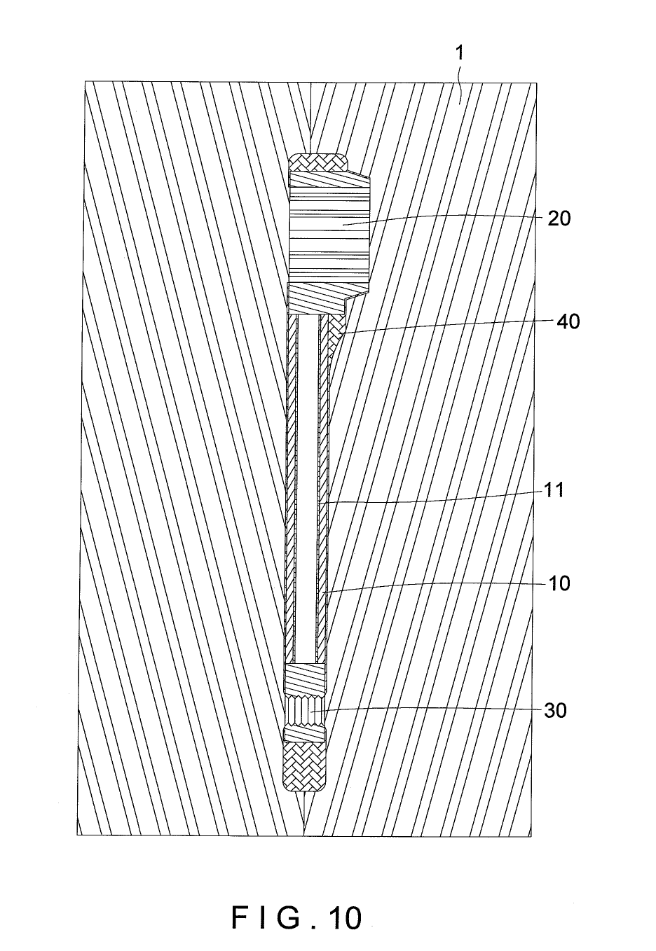

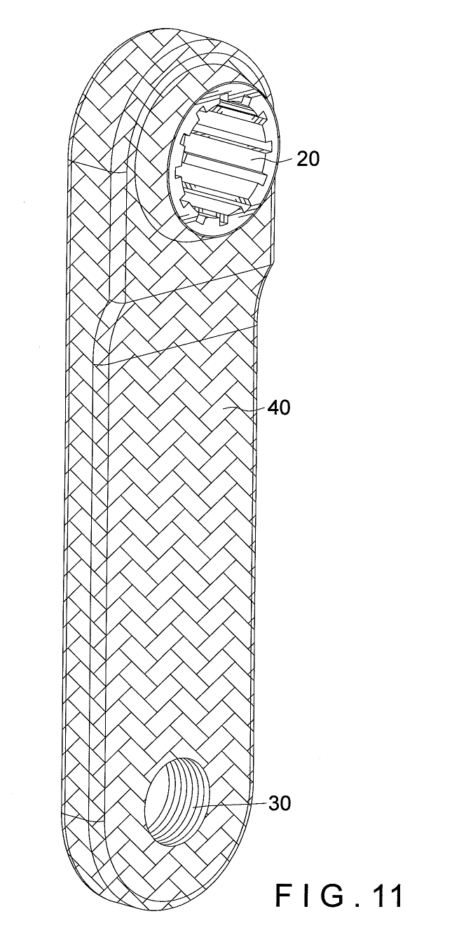

After the carbon-fiber cloth 40 is wrapped, the crank is subject to a heating process. Preferably, the crank is mounted in the mold insert 1 during the heating process. After the heating process, the carbon-fiber cloth 40 is snugly attached to the prepreg material 10 and the first 20 and second 30 connectors, as shown in FIG. 10. Additionally, the final product of the crank is shown in FIG. 11.

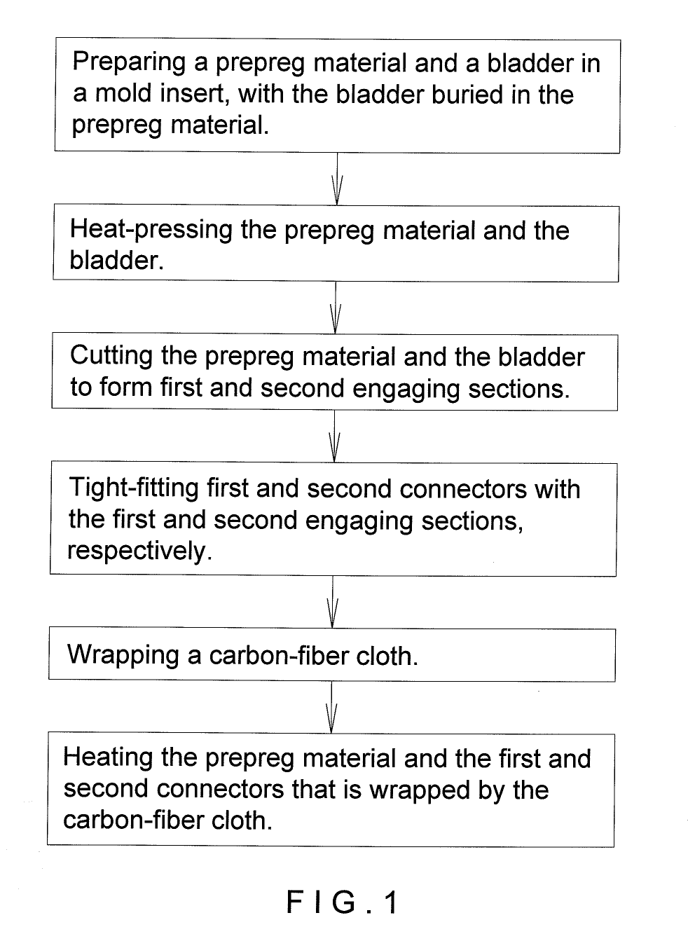

Referring to FIG. 1, a flow chart of a method for making a crank in accordance with the present invention includes 1) preparing a prepreg material 10 and a bladder 11 in a cavity 2 of a mold insert 1, with the bladder 11 buried in the prepreg material 10. 2) heat-pressing the prepreg material 10 and the bladder 11 to inflate the bladder 11 and cause the prepreg material 10 to compactly fit with the shape of the cavity 2. 3) cutting the prepreg material to form two engaging sections 16 and 17. 4) tight-fitting a first connector 20 with the engaging section 16 and a second connector 30 with the engaging section 17, respectively. 5) wrapping a carbon-fiber cloth 40 to cover up the prepreg material 10 and the first 20 and second 30 connectors. 6) heating the prepreg material 10 and the first 20 and second 30 connectors that is wrapped by the carbon-fiber cloth 40 in order to snugly attach the carbon-fiber cloth 40 to the prepreg material 10 and first 20 and second 30 connectors.

While the specific embodiments have been illustrated and described, numerous modifications are possible without significantly departing from the spirit of invention, and the scope of invention is limited only by the scope of the accompanying claims.

What is claimed is:

1. A method for making a crank of a bicycle comprising:
preparing a prepreg material and a bladder in a mold insert, with the bladder buried in the prepreg material;
heat-pressing the prepreg material in order to inflate the bladder and cause the bladder to inflate the prepreg material;
cutting the prepreg material and the bladder to form a first engaging section and a second engaging section;
tight-fitting a first connector with the first engaging section and a second connector with the second engaging section, respectively;
wrapping a carbon-fiber cloth to cover up the prepreg material and the first and second connectors; and
heating the prepreg material and the first and second connectors that is wrapped by the carbon-fiber cloth in order to snugly attach the carbon-fiber cloth thereon.

2. The method as claimed in claim 1 wherein the bladder has a mouth such that air is inflated in the bladder through the mouth, and wherein the prepreg material has a gap for the mouth to expose outside the prepreg material.

3. The method as claimed in claim 2 further comprising a valve joined with the mouth of the bladder for connecting with an air supply.

4. The method as claimed in claim 1 wherein the gap is with a minimum size such that an outer periphery of the mouth is in contact with the prepreg material.

5. The method as claimed in claim 1 wherein the first and second connectors are preferably made of metal, and wherein the first and second connectors are utilized to connect with a transmission gear of a bicycle and a pedal, respectively.

6. The method as claimed in claim 1 wherein each of the first and second connectors includes a protrusion, and wherein each of the first and second engaging sections includes a recess for tight-engagement with the protrusion, respectively.
